(19) United States
(12) Patent Application Publication
(10) Pub. No.: US 2025/0224275 A1
(43) Pub. Date: Jul. 10, 2025

(54) TECHNIQUES FOR COLOR BATCH CORRECTION

(71) Applicant: PPG INDUSTRIES OHIO, INC., Cleveland, OH (US)

(72) Inventor: Kevin Patrick Gallagher, Gibsonia, PA (US)

(73) Assignee: PPG INDUSTRIES OHIO, INC., Cleveland, OH (US)

(21) Appl. No.: 18/850,772

(22) PCT Filed: Feb. 13, 2023
(86) PCT No.: PCT/US2023/062454

§ 371 Date: Sep. 25, 2024

Related U.S. Application Data
(60) Provisional application No. 63/362,024, filed on Mar. 28, 2022.

(51) Int. Cl. G01J 3/50; G01J 3/40

(52) U.S. Cl. CPC G01J 3/50; G01J 3/40

(57) ABSTRACT

A system for performing color batch correction may include processors and computer-readable media having stored thereon executable instructions. In some examples, the executable instructions, if executed by the processors, cause the system to receive spectral data corresponding to a set of panels and convert the spectral for reach coated panel into a set of three-dimensional coordinates (e.g., lightness, red/green, and blue/yellow values). The system determines a change in each coordinate for each coated panel and analyze the change using a machine learning algorithm. The system receives data associated with a first coating and a target coating and determine one or more adjustments to make to the first coating to reduce a delta value between the coatings based on applying the machine learning algorithm. The system then outputs an indication of the one or more adjustments and a predicted reduction of the delta value.

### CROSS-REFERENCE TO RELATED APPLICATIONS

This application claims the benefit of and priority to U.S. Provisional Patent Application Ser. No. 63/362,024 filed on Mar. 28, 2022, and entitled “TECHNIQUES FOR COLOR BATCH CORRECTION,” which application is expressly incorporated herein by reference in its entirety.

### FIELD OF THE INVENTION

The present invention relates generally to coatings and more specifically to techniques for color batch correction.

### BACKGROUND OF THE INVENTION

Modern coatings provide various functions in industry and society. For example, vehicles and other types of machinery may be coated using paints or various other coatings in order to protect metal components from the elements (e.g., from rust) or to provide aesthetic visual effects. Properties of a coating (e.g., color, visual effects, texture, etc.) may be determined, in part, based on a chemical composition of the coating and may vary according to time of manufacture, geographic location (e.g., due to changes in altitude, climate, air quality, weather, etc.), or other environmental factors. In some cases, a coating mixed or used under different conditions may exhibit different visual properties when compared to another coating of the same chemical composition.

In some cases, correcting a manufactured batch of a coating may take a long time or may take many iterations of formula adjustments. There are many opportunities for new methods and systems that improve the coating matching and batch correction.

### SUMMARY OF THE INVENTION

The present invention may comprise systems, methods, or apparatus configured to perform color batch correction. In one example, the present invention includes a system for performing color batch correction, including one or more processors and one or more computer-readable media having stored thereon executable instructions. In some examples, the executable instructions include instructions that, when executed at the one or more processors, configure the system to perform various acts. For example, the system receives spectral data corresponding to a set of coated panels. Each coating of each coated panel includes one or more base coatings and at least an amount of a colorant, each coated panel of the set of coated panels having a different amount of the colorant. The system converts the spectral data for each coated panel of the set of coated panels into a set of three-dimensional coordinates. The three-dimensional coordinates include a lightness value (L*), a red/green value (a*), and a blue/yellow value (b*) in a color space. The system determines a change in each coordinate of the set of three-dimensional coordinates for each coated panel of the set of coated panels and analyzes, using a machine learning algorithm, the change in each coordinate of the set of three-dimensional coordinates for each coated panel of the set of coated panels. The system receives data associated with a first coating and a target coating. The data indicates a delta value calculated between the first coating and the target coating. The system determines one or more adjustments to make to the first coating and a predicted delta reduction value based at least in part on applying the machine learning algorithm. The system then outputs an indication of the one or more adjustments and the predicted delta reduction value.

In another example, the present example includes a method for performing color batch correction which may be executed on one or more processors of a computer system. The method may include receiving spectral data corresponding to a set of coated panels, in which each coating of each coated panel includes one or more base coatings and at least an amount of a colorant, each coated panel of the set of coated panels having a different amount of the colorant. The method includes converting the spectral data for each coated panel of the set of coated panels into a set of three-dimensional coordinates. The three-dimensional coordinates include a lightness value (L*), a red/green value (a*), and a blue/yellow value (b*) in a color space. The method includes determining a change in each coordinate of the set of three-dimensional coordinates for each coated panel of the set of coated panels and analyzing, using a machine learning algorithm, the change in each coordinate of the set of three-dimensional coordinates for each coated panel of the set of coated panels. The method includes receiving data associated with a first coating and a target coating, the data indicating a delta value calculated between the first coating and the target coating. The method includes determining one or more adjustments to make to the first coating and a predicted delta reduction value based at least in part on applying the machine learning algorithm and outputting an indication of the one or more adjustments and the predicted delta reduction value.

In another example, the present invention includes a non-transitory computer-readable medium including one or more computer-readable storage media having stored thereon computer-executable instructions that, when executed at a processor, cause a computer system to perform a method. The method includes receiving spectral data corresponding to a set of coated panels, in which each coating of each coated panel comprises one or more base coatings and at least an amount of a colorant, each coated panel of the set of coated panels having a different amount of the colorant. The method includes converting the spectral data for each coated panel of the set of coated panels into a set of three-dimensional coordinates. The three-dimensional coordinates include a lightness value (L*), a red/green value (a*), and a blue/yellow value (b*) in a color space. The method includes determining a change in each coordinate of the set of three-dimensional coordinates for each coated panel of the set of coated panels and analyzing, using a machine learning algorithm, the change in each coordinate of the set of three-dimensional coordinates for each coated panel of the set of coated panels. The method includes receiving data associated with a first coating and a target coating, the data indicating a delta value calculated between the first coating and the target coating. The method includes determining one or more adjustments to make to the first coating and a predicted delta reduction value based at least in part on applying the machine learning algorithm and outputting an indication of the one or more adjustments and the predicted delta reduction value.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings described below.

FIG. 1 illustrates a scheme 100 that supports techniques for color batch correction.

FIG. 2 illustrates a system 200 that supports techniques for color batch correction.

FIG. 3 illustrates a system 300 that supports techniques for color batch correction.

FIGS. 4-7 illustrate method flows that support techniques for color batch correction.

### DETAILED DESCRIPTION OF THE INVENTION

The present invention extends to systems, methods, or apparatus configured to perform batch color correction. Modern coatings provide various functions such as for protection or to provide aesthetic visual effects. In some examples, coatings may be produced according to custom requests, which may include indications of colors, effects, textures, etc. Such requests may also be associated with accuracy or tolerance thresholds which define specifications for production batches of a coating. For example, a request may include an indication that a coating be within a specified delta from a provided set of measurements (e.g., spectrophotometric data or three-dimensional coordinates in a color space). However, due to various factors, such as a time of manufacture, a geographic location (e.g., due to changes in altitude, climate, air quality, weather, etc.), various process parameters, or other environmental factors, production batches of a coating may not satisfy the indicated accuracy thresholds. In some examples, correcting a production batch may include performing several iterative adjustments (e.g., adding amounts of different colorants) and may, in some cases, take several days. Additionally, making a high number of adjustments may lead to a ruined or otherwise unusable production batch. Accordingly, it may be beneficial to implement techniques for color batch correction.

A system for performing color batch correction may include processors and computer-readable media having stored thereon executable instructions. In some examples, the executable instructions, if executed by the processors, cause the system to receive spectral data corresponding to a set of panels and convert the spectral for reach coated panel into a set of three-dimensional coordinates (e.g., lightness, red/green, and blue/yellow values). The system determines a change in each coordinate for each coated panel and analyze the change using a machine learning algorithm. The system receives data associated with a first coating and a target coating and determine one or more adjustments to make to the first coating to reduce a delta value between the coatings based on applying the machine learning algorithm. The system then outputs an indication of the one or more adjustments and a predicted reduction of the delta value.

Such techniques may include implementing a computer system which includes processors and computer-readable media having stored thereon executable instructions. The computer system may (e.g., if the instructions are executed at the processors) receive spectral data corresponding to a set of coated panels, which may, in some examples, be a training set of coated panels. Each coated panel may include at least one base coating and at least an amount of a colorant (e.g., a pigment, dye, toner, stain, etc.). Each coated panel may have a different amount of the colorant. For example, a first coated panel may have a least amount of a colorant, a second coated panel may have a greater among of the colorant than the first coated panel, etc. In some examples, the spectral data may include measurements taken at different angles (e.g., 15, 25, 45, 75, or 110 degrees) using a spectrophotometer.

The computer system may convert the spectral data for each coated panel into a set of three-dimensional coordinates. For example, the computer system may convert the spectral data into a lightness value (L*), a red/green value (a*), and a blue/yellow value (b*) which may be correspond to a point in a color space. The computer system may then determine a change in each coordinate for each coated panel. For example, the computer system may compute a delta value (e.g., a distance value between coordinates in the three-dimensional color space) between each pair of coated panels (e.g., a first coated panel having a first amount of the colorant and a second coated panel having a second amount of the colorant). The computer system may analyze the change in each coordinate using a machine learning algorithm, such as a supervised machine learning algorithm. For example, the computer system may calculate or otherwise determine a linear regression in each coordinate based on the computed delta values. In some implementations the linear regression models may be based on the delta values instead of absolute color coordinates of each coated panel of the set of coated panel. In some examples, the change may be calculated for measurements received at each angle of multiple angles. For example, a change may be calculated for a 15 degree measurement for each panel, a 25 degree measurement for each panel, etc.

The computer system may receive data associated with a first coating and a target coating such that the data includes an indication of a delta value calculated between the first coating and the target coating (e.g., between three-dimensional coordinates associated with the first coating and the target coating). In some implementations, the data may include a product identifier, a color, three-dimensional color coordinates, spectral data, or any combination thereof. The computer system may also receive data relating to the process parameters and/or environmental variables relating to the application of the respective coating. For example, process parameters may comprise fluid flow, bell speed, shaping air, electrostatic voltage, robot speed (e.g., tip speed or traverse speed), and other related parameters that describe the process of applying the coating. The environmental variables may comprise location, humidity, temperature, altitude, dew point, air pressure, and other related data points gathered at the area where the respective coating was applied and/or cured. The process parameters and/or environmental variables may be gathered by various different users of the computer system. For example, a user in Mexico may automatically provide at least portions of the described information to the computer system for processing within a machine learning model. Similarly, a user from Canada may also provide information for processing within a machine learning model. Each respective data set may comprise the unique environmental variables and process parameters associated with its location. The machine learning model may incorporate the received data and data from the resulting cured coatings.

The computer system may apply the machine learning model (e.g., the computed linear regressions) to the data to determine one or more adjustments to the coating ingredients and/or process parameters to make to the first coating given the environmental variables at the location where the first coating is being mixed and applied and a predicted reduction to the delta value between the first coating and the target coating based on the one or more adjustments. For example, the computer system may determine amounts of one or more pigments to add to the first coating and may use the linear regression models to predict the change in color (e.g., a reduction of the delta value) that may result from adding the one or more pigments to the first coating.

The computer system may output an indication of the one or more adjustments and the predicted delta reduction value. For example, the computer system may display, to a user of the computer system, the amounts of the one or more pigments, the predicted delta reduction value, a root mean square delta value, or any combination thereof. In some examples, the computer system may also add an indication of the target coating and the first coating to the training set of coated panels used to compute the linear regression models.

Aspects of the present disclosure may be implemented to realize one or more potential advantages. For example, techniques for color batch detection as described herein may allow for accurate prediction of adjustments which may result in a coating which satisfies accuracy thresholds associated with a target coating. Making such predictions may result in a decreased production time, more accurate color correction, among other benefits.

Additional aspects of the disclosure, including examples, advantages, etc. will be described in the context of system diagrams and method flows.

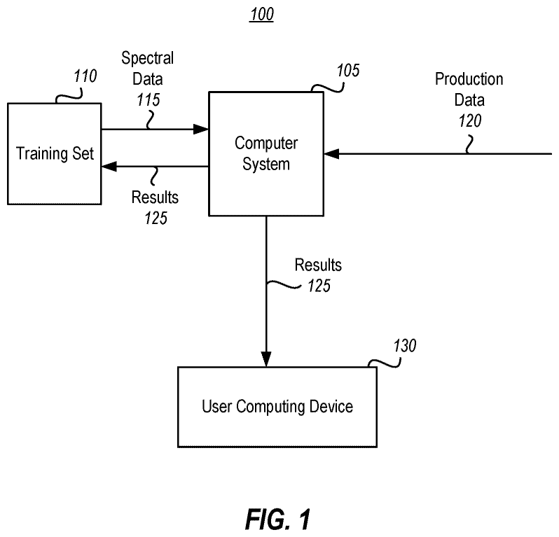

FIG. 1 illustrates an example of a scheme 100 that supports techniques for color batch correction, in accordance with various aspects of the present disclosure. The scheme 100 may include a computer system 105 and a training set 110. In some examples, the scheme 100 may also include a user computing device 130. The user computer device 130 may interact with, communicate with, or otherwise use the computer system 105 to perform color batch correction for a set of production data 120. In some examples, the computer system 105 may be located at a manufacturing facility of a first party or may be remote to the manufacturing system (e.g., may operate on a remote server and accessed over the internet using an application program interface),

In some examples, the production data 120 may be associated with a request for a coating that corresponds to a set of parameters received, for example, from a third party. For example, the third party may request a coating for use in an automotive shop or factory, an architectural firm, or for other such applications. A first party may manufacture a coating which corresponds to the production data 120. In some cases, the manufactured coating, and the corresponding production data 120, may not meet an accuracy threshold set by the third party (e.g., due to environmental conditions at a manufacturing facility, a geographic location, formula inaccuracies, etc.). For example, after producing a batch of the manufactured coating, the first party may measure a set of properties of the manufactured coating (e.g., using a spectrophotometer) and compare the measurements with parameters received from the third party. In such cases, the first party may correct (e.g., adjust a color, a visual effect, a texture, etc.) the manufactured coating such that it satisfies the accuracy threshold. Techniques for correcting the manufactured coating may include iterative adjustments to the manufactured coating. For example, the first party may iteratively add amounts of one or more pigments or other chemicals, take spectral measurements, and compare the measurements to the received parameters. The first party may repeat the correction techniques until the manufactured coating satisfies the accuracy threshold. In some cases, the correction process may take a long amount of time (e.g., a number of days or weeks), which may lead to an inefficient production process or a reduced production throughput.

The first party may employ the computer system 105 as part of the correction process. The computer system 105 may receive spectral data 115 associated with the training set 110, in which the training set 110 includes a set of physical coated panels. As used herein, a “coated panel” comprises any surface with a coating, including but not limited to panels on a vehicle, boat, airplane, and/or building. The coated panels included in the training set 110 may be selected based on one or more properties, such as color, included coatings, etc. For example, the coated panels of the training set 110 may each have base coatings and an amount of at least one colorant. In some examples, each coated panel may have a different amount of the at least one colorant, such that the spectral data 115 includes a set of measurements with different amounts of the colorant. In some implementations, the spectral data 115 may include measurements taken (e.g., with a spectrophotometer) at multiple angles, such as at any combination of 15, 25, 45, 75, or 110 degree angles.

The computer system 105 may convert the spectral data 115 (e.g., the spectrophotometric data associated with the coated panels of the training set 110) into a set of coordinates of a color space (e.g., a CIELab color space). The color space may define three-dimensional color coordinates including a lightness value (L*), a red/green value (a*), and a blue/yellow value (b*). Thus, color may be defined mathematically with respect to their location in the color space, distance from other colors, etc. Accordingly, the computer system 105 may determine a change in each coordinate of the set of three-dimensional coordinates for each coated panel of the set of coated panels. For example, the computer system 105 may calculate a distance (e.g., using a mathematical distance formula) between each pair of coated panels from the set of coated panels such that the computer system 105 determines how the three-dimensional color coordinates change with each amount of each colorant associated with the set of coated panels. The computer system 105 may analyze the change in each coordinate using a machine learning algorithm, such as a supervised machine learning algorithm. For example, the computer system 105 may determine a linear regression in each coordinate of the set of three-dimensional coordinates (e.g., based on the calculated distances between the color coordinates of each coated panel). In some examples, determined linear regressions may enable the computer system 105 to predict or otherwise determine how amounts of different colorants, different process parameters, and/or different environmental variables may change or affect the three-dimensional color coordinates of a coating. For example, the computer system 105 may predict that an amount of a first colorant (e.g., a red colorant) may change the lightness, red/green, or blue/yellow values of a coating by a predicted amount. In some examples, a user (e.g., the user computing device 130) may use the computer system 105 as part of a color batch correction process based on an ability of the computer system 105 to predict changes in color coordinates. In some examples, the change in each coordinate may be calculated for measurements received at each of multiple angles. For example, a change may be calculated using a 15 degree measurement for each panel, a 25 degree measurement for each panel, etc.

For example, the computer system 105 may receive production data 120, which may include data associated with a first coating and a target coating (e.g., including spectral data or three-dimensional color coordinates). The production data 120 may include an indication of a delta value (e.g., an error value) calculated between the first coating and the target coating. The delta value may, for example, be an indication of a distance between color coordinates associated with the first coating and the target coating and based on spectrophotometric measurements taken of the first coating and the target coating. In some implementations, the production data 120 may also include identifier data such as a product identifier, a color code, or both.

The computer system 105 may determine adjustments to make to the first coating and a predicted delta reduction value. For example, the computer system 105 may use the determined linear regressions to determine a set of adjustments to make to the first coating which will reduce a distance between the first coating and the target coating in the three-dimensional color space. The adjustments may include amounts of one or more pigments to add to the first coating and/or changes to an electrostatic voltage during the application of the coating. In some examples, the delta reduction value may indicate the predicted reduction of the distance between the first coating and the target coating in the three-dimensional color space. In some examples, the adjustments may include relatively small changes to the first coating which may result in minor changes to the three-dimensional location of the first coating in the color space. In some implementations, the computer system 105 may calculate, either serially or in parallel, multiple different sets of adjustments that may be applied to the first coating.

The computer system 105 may output the adjustments which may lead to the greatest reduction of the delta value between the first coating and the target coating. For example, the computer system 105 may send results 125, including an indication of the adjustments and the predicted delta reduction value to the user computing device 130, or may otherwise display the results 125 to a user of the computer system 105. In some implementations, the computer system 105 may also output an indication of a root mean square delta value associated with the set of adjustments. The displayed information may include adjustments to pigment amounts, adjustments to process parameters, adjustments to environmental variables (e.g., increasing the temperature within the paint area), and other similar adjustments. As explained above, the displayed information may comprise adjustments that were derived by the machine learning model using training data that was received from another paint shop at another location. Accordingly, training data can be shared between locations and used to increase accuracy and efficiency for all users of the computer system 105.

In some examples, the user computing device 130 or a user of the computer system 105 may make the adjustments to the first coating based on the output from the computer system 105. The user computing device 130 or a user of the computer system 105 may take measurements of the first coating (e.g., using a spectrophotometer) after making the adjustments and may input the measurements to the computer system 105 (e.g., as production data 120). The computer system 105 may convert the spectrophotometric measurements into three-dimensional color coordinates and may determine whether the adjusted first coating satisfies the accuracy threshold associated with the production request. If the adjusted first coating satisfies the accuracy threshold, the first coating may be passed to another system or process as part of a production flow. If the adjusted first coating does not satisfy the accuracy threshold, the computer system 105 may calculate an additional set of adjustments to make to further reduce the delta value between the first coating and the target coating. The scheme 100 may include performing iterative adjustments (e.g., one, two, three, etc., rounds of adjustments) to the first coating until the first coating satisfies the accuracy threshold.

The computer system 105 may also add the results 125 to the training set 110. For example, the computer system 105 may add an indication of the first coating, the target coating, related measurements or coordinates, and the suggested adjustments to make to the first coating. Accordingly, the computer system 105 may continually update the training set 110 and the determined linear regressions based on the results 125 and results of subsequent calculations. In some implementations, the training set 110 may be created for use with one target coating or may be determined or created for use with any or all potential target coatings offered by a first party. Implementing aspects of the scheme 100 may lead to a reduced production time or more accurate color correction, among other benefits.

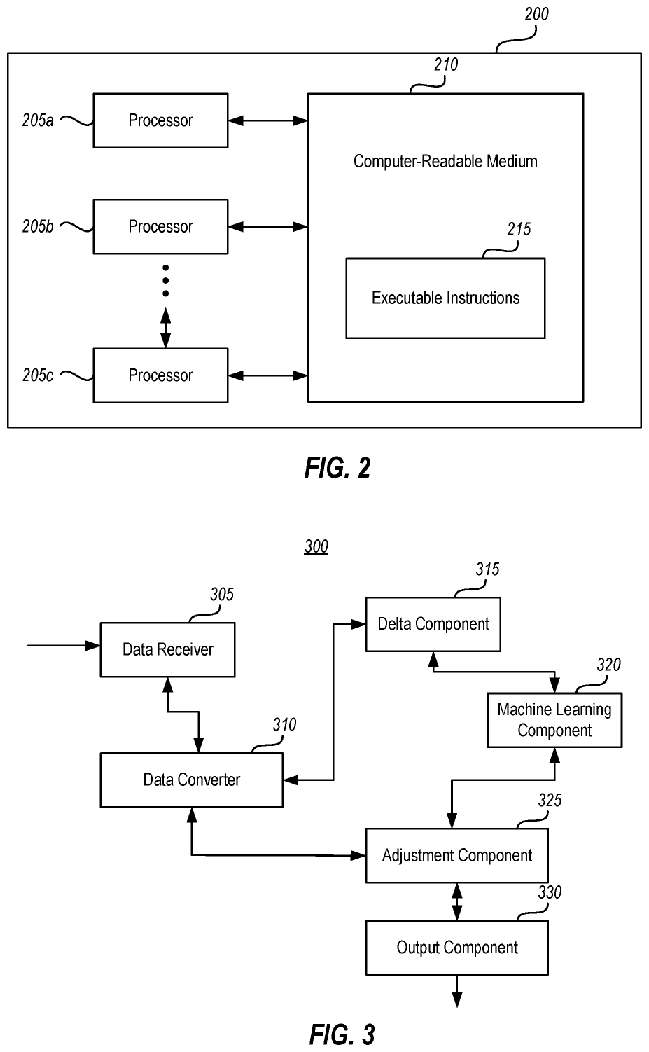

FIG. 2 illustrates an example of a computer system 200 that supports techniques for color batch correction, in accordance with various aspects of the present disclosure. The computer system 200 may implement aspects of a scheme 100 as described with reference to FIG. 1. The computer system 200 may include one or more processors 205 (e.g., a processor 205a, a processor 205b, a processor 205c, etc.), a computer-readable medium 210 and a set of executable instructions 215. The one or more processors 205 may include general purpose processors, central processing units, graphics processing units, digital signal processors, application specific integrated circuits, field-programmable gate arrays, or any combination thereof. The computer system 200 may be an example of means for performing methods and functions of the present disclosure as described herein.

For example, the set of executable instructions 215 may include instructions which, when executed by the one or more processors 205, may cause the computer system 200 to perform at least the following: receive spectral data corresponding to a set of coated panels, wherein each coating of each coated panel comprises one or more base coatings and at least an amount of a colorant, each coated panel of the set of coated panels having a different amount of the colorant; convert the spectral data for each coated panel of the set of coated panels into a set of three-dimensional coordinates, the three-dimensional coordinates comprising a lightness value (L*), a red/green value (a*), and a blue/yellow value (b*) in a color space; determine a change in each coordinate of the set of three-dimensional coordinates for each coated panel of the set of coated panels; analyze, using a machine learning model, the change in each coordinate of the set of three-dimensional coordinates for each coated panel of the set of coated panels; receive data associated with a first coating and a target coating, the data indicating a delta value calculated between the first coating and the target coating; determine one or more adjustments to make to the first coating and a predicted delta reduction value based at least in part on applying the machine learning algorithm; and output an indication of the one or more adjustments and the predicted delta reduction value. Implementing aspects of the system 200 may lead to a reduced production time or more accurate color correction, among other benefits.

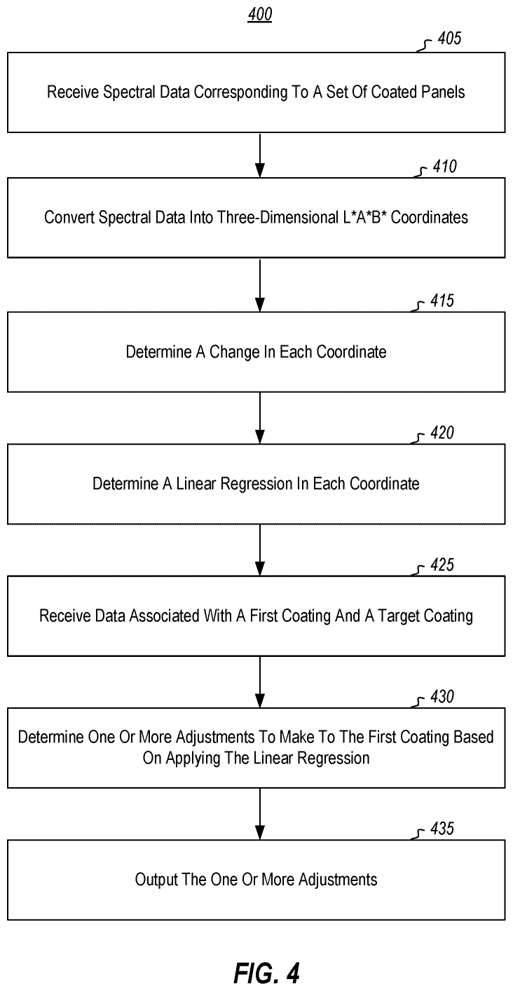

FIG. 3 illustrates an example of a system 300 that supports techniques for color batch correction, in accordance with various aspects of the present disclosure. In some examples, aspects of the system 300 may implement aspects of a scheme 100 or a system 200 as described with reference to FIGS. 1 and 2. For example, the system 300 may be implemented by or otherwise associated with one or more processors or one or more computer-readable media as described herein. The system 300 may include a data receiver 305, a data converter 310, a delta component 315, a machine learning component 320, an adjustment component 325, an output component 330, or any combination thereof. The components of the system 300 as described herein may communicate or otherwise share information as illustrated in FIG. 3 or in other ways, such as between components not illustrated. In some examples, the system 300 may include additional components or components may be removed or altered. The system 300 may be an example of means for performing methods and functions of the present disclosure as described herein.

The data receiver 305 may receive spectral data corresponding to a set of coated panels, wherein each coating of each coated panel comprises one or more base coatings and at least an amount of a colorant, each coated panel of the set of coated panels having a different amount of the colorant. In some examples, the spectral data may include measurements of each coated panel of the set of coated panels taken at multiple angles. In some implementations, the multiple angles may include 15, 25, 45, 75, or 110 degree angles, or any combination thereof. In some implementations, the spectra data for the set of coated panels may comprise measurements taken using a spectrophotometer.

The data converter 310 may convert the spectral data for each coated panel of the set of coated panels into a set of three-dimensional coordinates, the three-dimensional coordinates including a lightness value (L*), a re/green value (a*), and a blue/yellow value (b*) in a color space.

The delta component 315 may determine a change in each coordinate of the set of three-dimensional coordinates for each coated panel of the set of coated panels.

The machine learning component 320 may analyze, using a machine learning algorithm (e.g., a linear machine learning algorithm or other supervised machine learning algorithm), the change in each coordinate of the set of three-dimensional coordinates for each coated panel of the set of coated panels.

The data receiver 305 may receive data associated with a first coating and a target coating, the data indicating a delta value calculated between the first coating and the target coating. In some implementations, the data may include a product identifier, a color code, or both.

The adjustment component 325 may determine one or more adjustments to make to the first coating and a predicted delta reduction value based at least in part on applying the machine learning algorithm. In some implementations, determining the one or more adjustments may include determining amounts of one or more pigments to add to the first coating, in which the predicted delta reduction value is based on the amounts of the one or more pigments. In some examples, the system 300 may add an indication of the data associated with the target coating and the first coating, the one or more adjustments and the predicted delta reduction value to the set of coated panels received at the data receiver 305.

The output component 330 may output an indication of the one or more adjustments and the predicted delta reduction value. In some implementations, the output component 330 may display, to a user of the system 300, the amounts of the one or more pigments to add to the first coating, the predicted delta reduction value, a root mean square delta value, or any combination thereof. Implementing aspects of the system 300 may lead to a reduced production time or more accurate color correction, among other benefits.

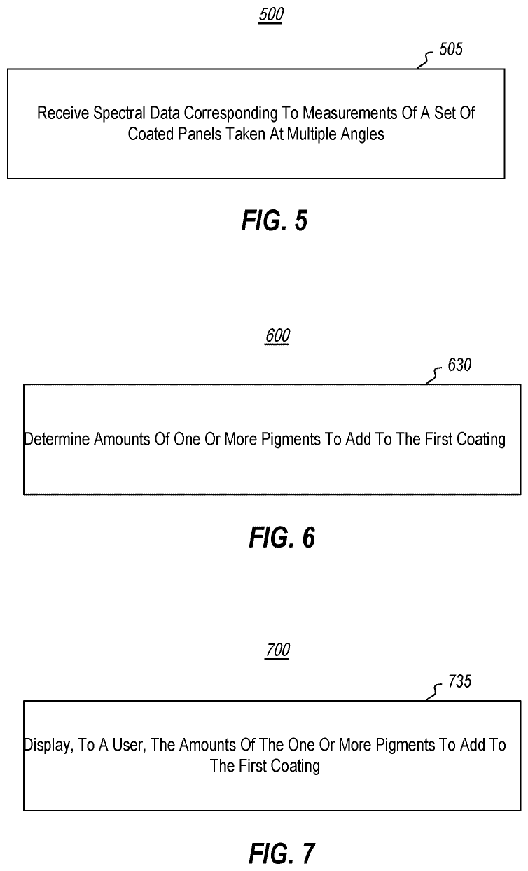

FIG. 4 illustrates an example of a method flow 400 that supports techniques for color batch correction, in accordance with various aspects of the present disclosure. In some examples, the method flow 400 may be implemented by or otherwise be associated with a scheme 100, a system 200, or a system 300 as described with reference to FIGS. 1-3. For example, the method flow 400 may be performed at a system including processors and computer-readable media such that the steps of the method flow 400 are represented by executable instructions stored on the computer-readable media. It is noted that the steps of the method flow 400 may be performed in a different order than illustrated, steps may be removed, or additional steps may be performed.

At 405, a system may receive spectra data corresponding to a set of coated panels, in which each coating of each coated panel includes one or more base coatings and at least an amount of a colorant, each coated panel of the set of coated panels having a different amount of the colorant.

At 410, the system may convert the spectral data for each coated panel of the set of coated panels into a set of three-dimensional coordinates, the three-dimensional coordinates including a lightness value (L*), a red/green value (a*), and a blue/yellow value (b*) in a color space.

At 415, the system may determine a change in each coordinate of the set of three-dimensional coordinates for each coated panel of the set of coated panels. For example, the system may determine a distance between three-dimensional locations of each coated panel of the set of coated panels.

At 420, the system may analyze, using a machine learning algorithm, the change in each coordinate of the set of three-dimensional coordinates for each coated panel of the set of coated panels.

At 425, the system may receive data associated with a first coating and a target coating, the data indicating a delta value calculated between the first coating and the target coating.

At 430, the system may determine one or more adjustments to make to the first coating and a predicted delta reduction value based at least in part on applying the machine learning algorithm.

At 435, the system may output an indication of the one or more adjustments and the predicted delta reduction value. Implementing aspects of the method flow 400 may lead to a reduced production time or more accurate color correction, among other benefits.

FIG. 5 illustrates an example of a method flow 500 that supports techniques for color batch correction, in accordance with various aspects of the present disclosure. In some examples, aspects of the method flow 500 may be implemented by or otherwise be associated with a scheme 100, a system 200, a system 300, or a method flow 400 as described with reference to FIGS. 1-4. For example, the method flow 500 may be performed at a system including processors and computer-readable media such that the steps of the method flow 500 are represented by executable instructions stored on the computer-readable media. It is noted that the steps of the method flow 500 may be performed in a different order than illustrated, steps may be removed, or additional steps may be performed.

In some examples, the method flow 500 may be performed in correspondence with the method flow 400. For example, at 505, a system may receive spectral data corresponding to measurements of a set of coated panels taken at multiple angles. In some implementations, the angles may include 15, 25, 45, 75, or 110 degree angles.

The system may, in some example, perform steps 410 through 435 as described with reference to FIG. 4 using or otherwise based on the spectral data corresponding to measurements taken at multiple angles.

For example, the system may convert the spectral data for each coated panel of the set of coated panels into a set of three-dimensional coordinates, the three-dimensional coordinates including a lightness value (L*), a red/green value (a*), and a blue/yellow value (b*) in a color space.

The system may determine a change in each coordinate of the set of three-dimensional coordinates for each coated panel of the set of coated panels. For example, the system may determine a distance between three-dimensional locations of each coated panel of the set of coated panels.

The system may analyze, using a machine learning algorithm, the change in each coordinate of the set of three-dimensional coordinates for each coated panel of the set of coated panels.

The system may receive data associated with a first coating and a target coating, the data indicating a delta value calculated between the first coating and the target coating.

The system may determine one or more adjustments to make to the first coating and a predicted delta reduction value based at least in part on applying the machine learning algorithm.

The system may output an indication of the one or more adjustments and the predicted delta reduction value. Implementing aspects of the method flow 500 may lead to a reduced production time or more accurate color correction, among other benefits.

FIG. 6 illustrates an example of a method flow 600 that supports techniques for color batch correction, in accordance with various aspects of the present disclosure. In some examples, aspects of the method flow 600 may be implemented by or otherwise be associated with a scheme 100, a system 200, a system 300, a method flow 400, or a method flow 500 as described with reference to FIGS. 1-5. For example, the method flow 600 may be performed at a system including processors and computer-readable media such that the steps of the method flow 600 are represented by executable instructions stored on the computer-readable media. It is noted that the steps of the method flow 600 may be performed in a different order than illustrated, steps may be removed, or additional steps may be performed.

In some examples, the method flow 600 may be performed in correspondence with the method flow 400 or the method flow 500 as described with reference to FIGS. 4 and 5. For example, in accordance with steps 405 through 425 of method flow 400 system may receive spectra data corresponding to a set of coated panels, in which each coating of each coated panel includes one or more base coatings and at least an amount of a colorant, each coated panel of the set of coated panels having a different amount of the colorant. In some examples, such as described with reference to FIG. 5, the spectral data may include measurements taken at multiple angles (e.g., at 15, 25, 45, 75, or 110 degree angles).

The system may convert the spectral data for each coated panel of the set of coated panels into a set of three-dimensional coordinates, the three-dimensional coordinates including a lightness value (L*), a red/green value (a*), and a blue/yellow value (b*) in a color space.

The system may determine a change in each coordinate of the set of three-dimensional coordinates for each coated panel of the set of coated panels. For example, the system may determine a distance between three-dimensional locations of each coated panel of the set of coated panels.

The system may analyze, using a machine learning algorithm, the change in each coordinate of the set of three-dimensional coordinates for each coated panel of the set of coated panels.

The system may receive data associated with a first coating and a target coating, the data indicating a delta value calculated between the first coating and the target coating.

With reference to FIG. 6, at 630, the system may determine amounts of one or more pigments to add to the first coating, in which the predicted delta reduction value is based on the amounts of the one or more pigments.

The system may then (e.g., in accordance with 435 of the method flow 400), output an indication of the amounts of the one or more pigments to add to the first coating and an indication of the predicted delta reduction value. Implementing aspects of the method flow 600 may lead to a reduced production time or more accurate color correction, among other benefits.

FIG. 7 illustrates an example of a method flow 700 that supports techniques for color batch correction, in accordance with various aspects of the present disclosure. In some examples, aspects of the method flow 700 may be implemented by or otherwise be associated with a scheme 100, a system 200, a system 300, a method flow 400, a method flow 500, or a method flow 600 as described with reference to FIGS. 1-6. For example, the method flow 700 may be performed at a system including processors and computer-readable media such that the steps of the method flow 700 are represented by executable instructions stored on the computer-readable media. It is noted that the steps of the method flow 700 may be performed in a different order than illustrated, steps may be removed, or additional steps may be performed.

In some examples, the method flow 700 may be performed in correspondence with the method flow 400, the method flow 500, or the method flow 600 as described with reference to FIGS. 4-6. For example, in accordance with steps 405 through 430 of the method flow 400 system may receive spectra data corresponding to a set of coated panels, in which each coating of each coated panel includes one or more base coatings and at least an amount of a colorant, each coated panel of the set of coated panels having a different amount of the colorant. In some examples, such as described with reference to FIG. 5, the spectral data may include measurements taken at multiple angles (e.g., at 15, 25, 45, 75, or 110 degree angles).

The system may convert the spectral data for each coated panel of the set of coated panels into a set of three-dimensional coordinates, the three-dimensional coordinates including a lightness value (L*), a red/green value (a*), and a blue/yellow value (b*) in a color space.

The system may determine a change in each coordinate of the set of three-dimensional coordinates for each coated panel of the set of coated panels. For example, the system may determine a distance between three-dimensional locations of each coated panel of the set of coated panels.

The system may analyze, using a machine learning algorithm, the change in each coordinate of the set of three-dimensional coordinates for each coated panel of the set of coated panels.

The system may receive data associated with a first coating and a target coating, the data indicating a delta value calculated between the first coating and the target coating.

The system may determine one or more adjustments to make to the first coating and a predicted delta reduction value based at least in part on applying the machine learning algorithm. In some examples, determining the one or more adjustments may include determining amounts of one or more pigments to add to the first coating, in which the predicted delta reduction value is based on the amounts of the one or more pigments.

With reference to FIG. 7, at 735, the system may display, to a user of the system, the amounts of the one or more pigments to add to the first coating, the predicted delta reduction value, a root mean square delta value, or any combination thereof. Implementing aspects of the method flow 700 may lead to a reduced production time or more accurate color correction, among other benefits.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different types of computer-readable media: computer storage media and transmission media.

Computer storage media (e.g., including non-transitory computer-readable media) are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system or one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The invention is further exemplified by the following aspects.

In a first aspect a system for performing color batch correction is provided, comprising: one or more processors; and one or more computer-readable media, preferably the non-transitory computer-readable medium according to any one of aspects twenty-one to twenty-five, having stored thereon executable instructions that, when executed at the one or more processors, configure the system to perform at least the following, preferably to perform the method according to any one of aspects sixteen to twenty: receive spectral data corresponding to a set of coated panels, wherein each coating of each coated panel comprises one or more base coatings and at least an amount of a colorant, each coated panel of the set of coated panels having a different amount of the colorant; convert the spectral data for each coated panel of the set of coated panels into a set of three-dimensional coordinates, the three-dimensional coordinates comprising a lightness value (L*), a red/green value (a*), and a blue/yellow value (b*) in a color space; determine a change in each coordinate of the set of three-dimensional coordinates for each coated panel of the set of coated panels; analyze, using a machine learning algorithm, the change in each coordinate of the set of three-dimensional coordinates for each coated panel of the set of coated panels; receive data associated with a first coating and a target coating, the data indicating a delta value calculated between the first coating and the target coating; determine one or more adjustments to make to the first coating and a predicted delta reduction value based at least in part on applying the machine learning algorithm; and output an indication of the one or more adjustments and the predicted delta reduction value.

According to a second aspect of the system for performing color batch correction as recited in aspect one, the executable instructions for receiving the spectral data comprise instructions that, when executed at a processor, configure the system to: receive spectral data associated with measurements of each coated panel of the set of coated panels taken at multiple angles.

According to a third aspect of the system for performing color batch correction as recited in aspect two, the multiple angles comprise 15, 25, 45, 75, or 110 degree angles, or any combination thereof.

According to a fourth aspect of the system for performing color batch correction as recited in aspects two or three, the multiple angles comprise angles between 15 and 110 degree.

According to a fifth aspect of the system for performing color batch correction as recited in aspects one to four, the executable instructions for determining the change in each coordinate of the three-dimensional coordinates comprises instructions that, when executed at a processor, configure the system to: determine the change in each coordinate of the set of three-dimensional coordinates on a per-angle basis, wherein a change is calculated at each angle of the multiple angles.

According to a sixth aspect of the system for performing color batch correction as recited in aspects one to five, the executable instructions include instructions that are executable to configure the system to: add an indication of the data associated with the target coating and the first coating, the one or more adjustments and the predicted delta reduction value to the set of coated panels.

According to a seventh aspect of the system for performing color batch correction as recited in aspects one to six, the executable instructions for determining the one or more adjustments include instructions that are executable to configure the system to: determine amounts of one or more pigments (or one or more colorants) to add to the first coating, wherein the predicted delta reduction value is based at least in part on the amounts of the one or more pigments.

According to an eighth aspect of the system for performing color batch correction as recited in aspects one to seven, the executable instructions for outputting the one or more adjustments and the predicted reduction of the delta value include instructions that are executable to configure the system to: display, to a user of the system, the amounts of the one or more pigments (or one or more colorants) to add to the first coating, the predicted delta reduction value, a root mean square delta value, or any combination thereof.

According to a nineth aspect of the system for performing color batch correction as recited in aspects one to eight, the machine learning algorithm comprises a linear regression algorithm or other supervised machine learning algorithms.

According to a tenth aspect of the system for performing color batch correction as recited in aspects one to nine, the spectral data for the set of coated panels comprise measurements taken using a spectrophotometer.

According to an eleventh aspect of the system for performing color batch correction as recited in aspects one to ten, the data associated with the target coating and the first coating comprise a product identifier, a color code, or both.

According to a twelfth aspect of the system for performing color batch correction as recited in aspects one to eleven, the coated panels have a different amount of the colorant.

According to a thirteenth aspect of the system for performing color batch correction as recited in aspects one to twelve, determine the change further includes compute a delta value (e.g., a distance value between coordinates in the three-dimensional color space) between each pair of coated panels (e.g., a first coated panel having a first amount of the colorant and a second coated panel having a second amount of the colorant).

According to a fourteenth aspect of the system for performing color batch correction as recited in aspects one to thirteen, analyze, using a machine learning algorithm, further includes calculate or otherwise determine a linear regression in each coordinate based on the computed delta values.

According to a fifteenth aspect of the system for performing color batch correction as recited in aspects one to fourteen, determine one or more adjustments further includes apply the computed linear regressions to the data associated with a first coating and a target coating to determine one or more adjustments (e.g. an amount of pigments or colorants) to make to the first coating, preferably to reduce the distance between the first coating and the target coating in the three-dimensional color space, and a predicted reduction to the delta value between the first coating and the target coating based on the one or more adjustments.

In a sixteenth aspect, a method for performing color batch correction is provided, the method executed on one or more processors of a computer system, preferably the system according to any one of aspects one to fifteen, the method comprising: receiving spectral data corresponding to a set of coated panels, wherein each coating of each coated panel comprises one or more base coatings and at least an amount of a colorant, each coated panel of the set of coated panels having a different amount of the colorant; converting the spectral data for each coated panel of the set of coated panels into a set of three-dimensional coordinates, the three-dimensional coordinates comprising a lightness value (L*), a red/green value (a*), and a blue/yellow value (b*) in a color space; determining a change in each coordinate of the set of three-dimensional coordinates for each coated panel of the set of coated panels; analyzing, using a machine learning algorithm, the change in each coordinate of the set of three-dimensional coordinates for each coated panel of the set of coated panels; receiving data associated with a first coating and a target coating, the data indicating a delta value calculated between the first coating and the target coating; determining one or more adjustments to make to the first coating and a predicted delta reduction value based at least in part on applying the machine learning algorithm; and outputting an indication of the one or more adjustments and the predicted delta reduction value.

According to a seventeenth aspect of the method for performing color batch correction as recited in aspect sixteen, receiving the spectral data comprises: receiving spectral data associated with measurements of each coated panel of the set of coated panels taken at multiple angles.

According to an eighteenth aspect of the method for performing color batch correction as recited in aspects sixteen or seventeen, the multiple angles comprise 15, 25, 45, 75, or 110 degree angles, or any combination thereof.

According to a nineteenth aspect of the method for performing color batch correction as recited in aspects sixteen to eighteen, the method further comprises: adding an indication of the data associated with the target coating and the first coating, the one or more adjustments and the predicted delta reduction value to the set of coated panels.

According to a twentieth aspect of the method for performing color batch correction as recited in aspects sixteen to nineteen, determining the one or more adjustments further comprises: determining amounts of one or more pigments to add to the first coating, wherein the predicted delta reduction value is based at least in part on the amounts of the one or more pigments.

In a twenty first aspect, a non-transitory computer-readable medium is provided comprising one or more computer-readable storage media having stored thereon computer-executable instructions that, if executed at a processor, cause a computer system, preferably the system according to any one of aspects one to fifteen, to perform a method for performing color batch correction, preferably the method according to any one of aspects sixteen to twenty, the method comprising: receiving spectral data corresponding to a set of coated panels, wherein each coating of each coated panel comprises one or more base coatings and at least an amount of a colorant, each coated panel of the set of coated panels having a different amount of the colorant; converting the spectral data for each coated panel of the set of coated panels into a set of three-dimensional coordinates, the three-dimensional coordinates comprising a lightness value (L*), a red/green value (a*), and a blue/yellow value (b*) in a color space; determining a change in each coordinate of the set of three-dimensional coordinates for each coated panel of the set of coated panels; analyzing, using a machine learning algorithm, the change in each coordinate of the three-dimensional coordinates for each coated panel of the set of coated panels; receiving data associated with a first coating and a target coating, the data indicating a delta value calculated between the first coating and the target coating; determining one or more adjustments to make to the first coating and a predicted delta reduction value based at least in part on applying the machine learning algorithm; and outputting the one or more adjustments and the predicted delta reduction value.

According to a twenty second aspect of the non-transitory computer-readable medium as recited in aspect twenty-one, the computer-executable instructions for receiving the spectral data comprise computer-executable instructions that, when executed at a processor, cause the computer system the method comprising: receiving spectral data associated with measurements of each coated panel of the set of coated panels taken at multiple angles.

According to a twenty third aspect of the non-transitory computer-readable medium as recited in aspects twenty-one or twenty-two, the multiple angles comprise 15, 25, 45, 75, or 110 degree angles, or any combination thereof.

According to a twenty fourth aspect of the non-transitory computer-readable medium as recited in aspect twenty-one to twenty-three, the computer-executable instructions comprise: adding an indication of the data associated with the target coating and the first coating, the one or more adjustments and the predicted delta reduction value to the set of coated panels.

According to a twenty fifth aspect of the non-transitory computer-readable medium as recited in aspect twenty-one to twenty-four, the computer-executable instructions for determining the one or more adjustments further comprise computer-executable instructions that, when executed at a processor, cause the computer system to perform the method comprising: determining amounts of one or more pigments to add to the first coating, wherein the predicted delta reduction value is based at least in part on the amounts of the one or more pigments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (canceled)

21. A system for performing color batch correction, comprising:
one or more processors; and
one or more computer-readable media having stored thereon executable instructions that, when executed at the one or more processors, configure the system to perform at least the following:
receive spectral data corresponding to a set of coated panels, wherein each coating of each coated panel comprises one or more base coatings and at least an amount of a colorant, each coated panel of the set of coated panels having a different amount of the colorant;
convert the spectral data for each coated panel of the set of coated panels into a set of three-dimensional coordinates, the three-dimensional coordinates comprising a lightness value (L*), a red/green value (a*), and a blue/yellow value (b*) in a color space;
determine a change in each coordinate of the set of three-dimensional coordinates for each coated panel of the set of coated panels;
analyze, using a machine learning algorithm, the change in each coordinate of the set of three-dimensional coordinates for each coated panel of the set of coated panels;
receive data associated with a first coating and a target coating, the data indicating a delta value calculated between the first coating and the target coating;
determine one or more adjustments to make to the first coating and a predicted delta reduction value based at least in part on applying the machine learning algorithm; and
output an indication of the one or more adjustments and the predicted delta reduction value.

22. The system of claim 21, wherein the executable instructions for receiving the spectral data comprise instructions that, when executed at a processor, configure the system to:
receive spectral data associated with measurements of each coated panel of the set of coated panels taken at multiple angles.

23. The system of claim 22, wherein the multiple angles comprise 15, 25, 45, 75, or 110 degree angles, or any combination thereof.

24. The system of claim 22, wherein the executable instructions for determining the change in each coordinate of the three-dimensional coordinates comprises instructions that, when executed at a processor, configure the system to:
determine the change in each coordinate of the set of three-dimensional coordinates on a per-angle basis, wherein a change is calculated at each angle of the multiple angles.

25. The system of claim 22, where in the executable instructions include instructions that are executable to configure the system to:
add an indication of the data associated with the target coating and the first coating, the one or more adjustments and the predicted delta reduction value to the set of coated panels.

26. The system of claim 21, wherein the executable instructions for determining the one or more adjustments include instructions that are executable to configure the system to:
determine amounts of one or more pigments to add to the first coating, wherein the predicted delta reduction value is based at least in part on the amounts of the one or more pigments.

27. The system of claim 21, wherein the executable instructions for outputting the one or more adjustments and the predicted delta reduction value include instructions that are executable to configure the system to:
display, to a user of the system, the amounts of one or more pigments to add to the first coating, the predicted delta reduction value, a root mean square delta value, or any combination thereof.

28. The system of claim 21, wherein the machine learning algorithm comprises a linear regression algorithm or other supervised machine learning algorithms.

29. The system of claim 21, wherein the spectral data for the set of coated panels comprise measurements taken using a spectrophotometer.

30. The system of claim 21, wherein the data associated with the target coating and the first coating comprise a product identifier, a color code, or both.

31. A method for performing color batch correction, the method executed on one or more processors of a computer system, the method comprising:
receiving spectral data corresponding to a set of coated panels, wherein each coating of each coated panel comprises one or more base coatings and at least an amount of a colorant, each coated panel of the set of coated panels having a different amount of the colorant;
converting the spectral data for each coated panel of the set of coated panels into a set of three-dimensional coordinates, the three-dimensional coordinates comprising a lightness value (L*), a red/green value (a*), and a blue/yellow value (b*) in a color space;
determining a change in each coordinate of the set of three-dimensional coordinates for each coated panel of the set of coated panels;
analyzing, using a machine learning algorithm, the change in each coordinate of the set of three-dimensional coordinates for each coated panel of the set of coated panels;
receiving data associated with a first coating and a target coating, the data indicating a delta value calculated between the first coating and the target coating;
determining one or more adjustments to make to the first coating and a predicted delta reduction value based at least in part on applying the machine learning algorithm; and
outputting an indication of the one or more adjustments and the predicted delta reduction value.

32. The method of claim 31, wherein receiving the spectral data comprises:
receiving spectral data associated with measurements of each coated panel of the set of coated panels taken at multiple angles.

33. The method of claim 32, wherein the multiple angles comprise 15, 25, 45, 75, or 110 degree angles, or any combination thereof.

34. The method of claim 31, further comprising:
adding an indication of the data associated with the target coating and the first coating, the one or more adjustments and the predicted delta reduction value to the set of coated panels.

35. The method of claim 31, wherein determining the one or more adjustments further comprises:
determining amounts of one or more pigments to add to the first coating, wherein the predicted delta reduction value is based at least in part on the amounts of the one or more pigments.

36. A non-transitory computer-readable medium comprising one or more computer-readable storage media having stored thereon computer-executable instructions that, if executed at a processor, cause a computer system to perform a method for performing color batch correction, the method comprising:
receiving spectral data corresponding to a set of coated panels, wherein each coating of each coated panel comprises one or more base coatings and at least an amount of a colorant, each coated panel of the set of coated panels having a different amount of the colorant;
converting the spectral data for each coated panel of the set of coated panels into a set of three-dimensional coordinates, the three-dimensional coordinates comprising a lightness value (L*), a red/green value (a*), and a blue/yellow value (b*) in a color space;
determining a change in each coordinate of the set of three-dimensional coordinates for each coated panel of the set of coated panels;
analyzing, using a machine learning algorithm, the change in each coordinate of the three-dimensional coordinates for each coated panel of the set of coated panels;
receiving data associated with a first coating and a target coating, the data indicating a delta value calculated between the first coating and the target coating;
determining one or more adjustments to make to the first coating and a predicted delta reduction value based at least in part on applying the machine learning algorithm; and
outputting the one or more adjustments and the predicted delta reduction value.

37. The non-transitory computer-readable medium of claim 36, wherein the computer-executable instructions for receiving the spectral data comprise computer-executable instructions that, when executed at a processor, cause the computer system the method comprising:
receiving spectral data associated with measurements of each coated panel of the set of coated panels taken at multiple angles.

38. The non-transitory computer-readable medium of claim 37, wherein the multiple angles comprise 15, 25, 45, 75, or 110 degree angles, or any combination thereof.

39. The non-transitory computer-readable medium of claim 36, wherein the computer-executable instructions comprise:
adding an indication of the data associated with the target coating and the first coating, the one or more adjustments and the predicted delta reduction value to the set of coated panels.

40. The non-transitory computer-readable medium of claim 36, wherein the computer-executable instructions for determining the one or more adjustments further comprise computer-executable instructions that, when executed at a processor, cause the computer system to perform the method comprising:
determining amounts of one or more pigments to add to the first coating, wherein the predicted delta reduction value is based at least in part on the amounts of the one or more pigments.
